(19) United States
(12) Patent Application Publication
(10) Pub. No.: US 2006/0214808 A1
(43) Pub. Date: Sep. 28, 2006

(54) Device of telephonic alarm for industrial refrigerators

(76) Inventor: Maurizio Fusco, Rome (IT)

Correspondence Address: OLIFF & BERRIDGE, PLC, P.O. BOX 19928, ALEXANDRIA, VA, 22320, US

(21) Appl. No.: 10/566,592

(22) PCT Filed: Jul. 30, 2004
(86) PCT No.: PCT/IT04/00425

§ 371 Date: Jan. 31, 2006

(30) Foreign Application Priority Data
Jul. 31, 2003 (IT) RM2003 U 000138

(51) Int. Cl. G08B 17/00

(52) U.S. Cl. 340/585; 379/22.03; 340/531

(57) ABSTRACT

Device planned to inform, by telephonic vocal messages, the danger of decay of medicines and foodstuffs or, in general, perishable goods preserved in refrigerating units in pharmacies, drug-stores, supermarkets and similar, giving an information about the condition of the refrigerator. Device that includes one or more sensors, even cordless, connected to a circuit that includes a microcontroller with a software application that manages, jointly to the peripherals included into the circuit: the measurement and the control of temperatures; the remote and local signalling of alarm; the warning about the loss or return of energy; the vision, on the display, of the temperatures and working's values; the remote enquiry and programming.

The extant invention refers to security′ systems branch.

This present invention refers to an electronic device of telephonic alarm that can be used to prevent the danger of decay of medicines, foodstuffs or other perishable goods kept in industrial refrigerators in pharmacies, drug-stores, supermarkets etc.

Those existing systems serve only in a limited way this purpose. The aim of present invention is to extend the safety level out of local sphere and to inform those responsible through the telephone at the right moment so to prevent huge losses.

The device, hence, is extremely important during the night and the festivity closings or anytime the refrigerating-units are not under personal control.

However, everybody knows that damage to the refrigerating system or the lack of energy, could cause heavy economical losses due to the decay of the goods destined to sale.

The aim of present invention is to realise a device that is able to give timely signal through telephone to concerned persons, when the programmed temperature is exceeded or altered giving sufficient time to transfer the goods in another freezer and thus to avoid losses.

Another advantage of present device is that, thanks to the sensors connected to their circuit, it records constantly the temperatures of the controlled freezers. Thus it is possible to employ this characteristic for the electronic data processing and archiving of the temperature data as indicated by the European norms HACCP.

The device, with the present innovation, is realised with circuit elements, except the sensors, in a unique box to give the opportunity to be easily installed to control many freezers, located in different locations.

All the components used for the device are common. But, what is new and distinctive is their assembling and utility. This newly invented device is a solution for many problems regarding refrigerators.

The attached drawing illustrates the function of the newly invented device, with an example of a single unit of refrigerator.

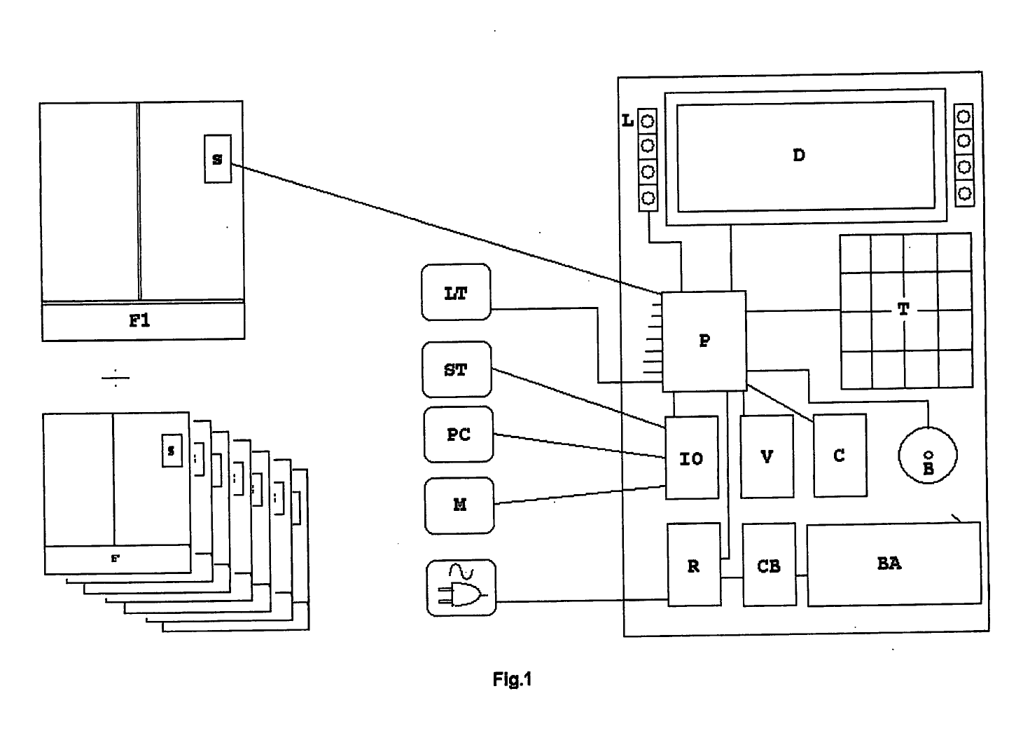

As we can notice by the drawing, the temperature in the freezer FIG.1 (F1) is constantly controlled by the sensor FIG.1 (S), connected to the device where there is the circuit with the microcontroller on board FIG.1 (P). The value of temperature will appear on the display FIG.1 (D).

If the temperature of the freezer FIG.1 (F1) goes over the programmed level, either with higher or lower temperature (included function of programmable thermostat) or remain functioning more than the time programmed (included function of programmable timer) the microcontroller will send: 1) a local acoustic alarm through the buzzer FIG.1 (B) and 2) an optical alarm through the led FIG.1 (L) allotted to freezer FIG.1 (F1).

At the same time to the local alarm, the device will manage the remote alarm using the telephonic line FIG.1 (LT), that can be PSTN, GSM or similar and will send the calls in the prefixed order to the memorised numbers and then, through the integrated circuit having the vocal messages FIG.1 (V), will give notice to the concerning person indicating the condition of the freezer and requesting an immediate attention.

Once received the alarm's message, it is possible to stop sending further warnings by means of a PIN code send by the telephone itself, blocking the transmission of following calls programmed in the device.

Moreover, more functions have been foreseen in the device as: the archiving of the temperature's data as requested from European norms HACCP, the control of power, the remote checking of refrigerating system, the remote programming, the auxiliary contacts for the interfacing, as voice dialler, on burglary-alarm and fire-alarm systems existing and/or the connection for alarm push-buttons.

Archiving of the temperatures as requested from European norms HACCP. The values of the temperature captured from the sensor FIG.1 (S) are deposited in the device's not volatile memory. They can be taken off through the interface I/O FIG.1 (IO), through a direct connection, an external module FIG.1 (M), and can be elaborated and archived on a personal computer with a specific software application or can be send to a printer directly FIG. 1 (ST).

Control of Power.

The device, equipped with an emergency battery FIG.1 (BA) with a right recharge circuit FIG.1 (CB), is able to inform about the loss and the return of power. In case of loss FIG.1 (R), after a programmed time (included function in the programmable timer), the device will send a message about the absence of power.

If the power is back FIG.1 (R) before the inside temperature of the freezer reaches the thermostat alarm′ threshold (included function of the programmable thermostat), the device will send a message informing the return of the power to avoid unnecessary intervention.

Remote consulting of the refrigerating system's conditions. By calling the telephone number where the device is connected, the answering circuit FIG. 1(C) will be activated automatically and will make possible to send search code to make an enquiry about the system through tones DTMF. Each search code will have an attached vocal message, memorised in the integrated circuit. FIG. 1(V).

Remote Programming.

Besides the local programming of the functioning parameters using the keypad of the device FIG. 1(T) or an external module FIG. 1(M) or through a personal computer FIG. 1(PC) that contains a software of programming, it is possible to have remote programming and remote assistance.

Such functions are available, from remote, using a personal computer which has a software of remote management of the device and using as vectors, analogical modem, GSM terminals and similar.

Auxiliary Contacts.

Such free contacts on the device, are foreseen for the interfacing towards burglary alarm and fire alarm systems and for the connection of emergency push-buttons inside the freezing area, that are useful to the responsible person, if necessary.

The present device that has been described above, has ample possibility to be modified without any alteration in its basic and fundamental design.

1. Telephonic alarm device able to send signal, through vocal messages on telephonic lines (PSTN, GSM or similar) informing the risk of decay of the perishable goods preserved in the refrigerating units and freezing systems. Device characterized by the fact that includes a circuit for the control of temperature, compound by external sensors, electronic programmable thermostats and electronic programmable timers, is able to activate automatically a circuit and send signals of alarm through telephone, when occurs a variation in the temperature (high or low) set-up. This device activates the telephone line automatically, selects the telephone numbers from its memory and transmits the alarm call, registered in vocal synthesis, associated to the fridge in damage. Simultaneously, a loud alarm will locally be activated through the buzzer and is visible through the led diode attached to that particular fridge.

2. Device, as claimed in claim 1 characterized by the fact that includes one or more sensors, even cordless, installed in the refrigerating units to acquire and monitory the measure of temperatures, connected to the basic circuit. The circuit, equipped with buffer for the storage of data, allows to share the data through the connection interface, with the outside (type USB, RS232 port or similar). This makes possible to store the history of temperature measurement for a successive electronic data processing and electronic data storage, as indicated by the European norms HACCP.

3. Device, as claimed in claim 1 characterized by the fact that includes an external module (type USB, RS232 port or similar) with solid-state memory on board can be connected to the device, through the interface connection and then to a personal computer, and vice-versa, for the data exchange (programming, temperatures data, etc.), a firmware for the management and functioning of the circuit with a specific software application is included for the use of the different functions of the device.

4. Device, as claimed in claim 1 characterized by the fact that includes the possibility to make enquiry, from anywhere, through the telephonic line and DTMF tones, about the fridge's conditions, receiving reply to the specific questions, through synthesised vocal messages resident in the dedicated supplemented circuit and a keypad for the manual programming and the verification of the system.

5. Device, as claimed in claim 2 characterized by the fact that includes an external module (type USB, RS232 port or similar) with solid-state memory on board can be connected to the device, through the interface connection and then to a personal computer, and vice-versa, for the data exchange (programming, temperatures data, etc.), a firmware for the management and functioning of the circuit with a specific software application is included for the use of the different functions of the device.

6. Device, as claimed in claim 2 characterized by the fact that includes the possibility to make enquiry, from anywhere, through the telephonic line and DTMF tones, about the fridge's conditions, receiving reply to the specific questions, through synthesised vocal messages resident in the dedicated supplemented circuit and a keypad for the manual programming and the verification of the system.

7. Device, as claimed in claim 3 characterized by the fact that includes the possibility to make enquiry, from anywhere, through the telephonic line and DTMF tones, about the fridge's conditions, receiving reply to the specific questions, through synthesised vocal messages resident in the dedicated supplemented circuit and a keypad for the manual programming and the verification of the system.
